(19) United States
(12) Patent Application Publication
(10) Pub. No.: US 2023/0171632 A1
(43) Pub. Date: Jun. 1, 2023

(54) REDUNDANT WIRELESS COMMUNICATION MESSAGE REMOVAL

(71) Applicant: QUALCOMM Incorporated, San Diego, CA (US)

(72) Inventors: Hargovind Prasad BANSAL, Hyderabad (IN); Tom CHIN, San Diego, CA (US)

(21) Appl. No.: 17/921,586

(22) PCT Filed: Jan. 25, 2021
(86) PCT No.: PCT/US2021/014963

§ 371 Date: Oct. 26, 2022

(30) Foreign Application Priority Data
Jun. 30, 2020 (IN) 202041027775

(51) Int. Cl. H04W 24/10; H04W 24/08

(52) U.S. Cl. CPC H04W 24/10; H04W 24/08

(57) ABSTRACT

A method performed by a user equipment, UE, includes receiving a measurement configuration message comprising a logging measurement configuration from a base station. The method also includes initiating a minimization of drive tests, MDT, session in response to receiving the measurement configuration message and generating (802) an MDT log at each logging instance of a number of logging instances until completion of the MDT session. The method further includes transmitting (806), to the base station, the MDT log of each logging instance after completing the MDT session. For each received MDT log, the method determines (804) whether a current information element of a current measurement collected at a current logging instance matches a prior information element of a prior measurement collected at a prior logging instance, and removes the current information element from the MDT log of the current logging instance when the current measurement matches the prior information element.

### CROSS-REFERENCE TO RELATED APPLICATION

The present application claims priority to India Patent Application No. 202041027775, filed on Jun. 30, 2020, and titled “REDUNDANT INFORMATION REMOVAL TO REDUCE RADIO RESOURCE CONTROL (RRC) MESSAGE SEGMENTATION,” the disclosure of which is expressly incorporated by reference in its entirety.

### FIELD OF THE DISCLOSURE

Aspects of the present disclosure generally relate to wireless communication, and more particularly to techniques and apparatuses for reducing wireless communication messages, such as new radio (NR), radio resource control (RRC) messages and network over the air signaling messages.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP).

A wireless communication network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In one aspect of the present disclosure, a method for wireless communication by a user equipment (UE) includes generating a number of measurement logs based on measurements performed by the UE, each measurement log generated at a different measurement instance. The method further includes removing, for each measurement instance, a measurement from a measurement log of a current measurement instance when the measurement matches a prior measurement collected at a prior measurement instance. The method still further includes transmitting, to a base station, a message comprising the number measurement logs.

Another aspect of the present disclosure is directed to an apparatus for wireless communication at a UE. The apparatus includes means for generating a number of measurement logs based on measurements performed by the UE, each measurement log generated at a different measurement instance. The apparatus further includes means for removing, for each measurement instance, a measurement from a measurement log of a current measurement instance when the measurement matches a prior measurement collected at a prior measurement instance. The apparatus still further includes means for transmitting, to a base station, a message comprising the number measurement logs.

In another aspect of the present disclosure, a non-transitory computer-readable medium with non-transitory program code recorded thereon for wireless communication by a UE is disclosed. The program code is executed by a processor and includes program code to generate a number of measurement logs based on measurements performed by the UE, each measurement log generated at a different measurement instance. The program code further includes program code to remove, for each measurement instance, a measurement from a measurement log of a current measurement instance when the measurement matches a prior measurement collected at a prior measurement instance. The program code still further includes program code to transmit, to a base station, a message comprising the number measurement logs.

Another aspect of the present disclosure is directed to an apparatus for wireless communication at a UE. The apparatus includes a processor, a memory coupled with the processor, instructions stored in the memory and operable, when executed by the processor, to cause the apparatus to generate a number of measurement logs based on measurements performed by the UE, each measurement log generated at a different measurement instance. The instructions also cause the apparatus to remove, for each measurement instance, a measurement from a measurement log of a current measurement instance when the measurement matches a prior measurement collected at a prior measurement instance. The instructions furhter cause the apparatus to transmit, to a base station, a message comprising the number measurement logs.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description, may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a timing diagram illustrating an example of a minimization of drive tests (MDT) process.

FIG. 4A illustrates an example of a logged measurement configuration message.

FIG. 4B illustrates an example of a Bluetooth measurement information element and a wireless local area network measurement information element.

FIG. 5 is a flow diagram illustrating an example process for removing a redundant information element, in accordance with aspects of the present disclosure.

FIG. 6 illustrates an example of a serving cell information element for serving cell measurements and a carrier frequency information element for carrier frequency measurements, in accordance with aspects of the present disclosure.

FIG. 7 illustrates an example of an updated wireless local area network (WLAN) information element for WLAN measurements, in accordance with aspects of the present disclosure.

FIG. 8 is a flow diagram illustrating an example process performed, for example, by a user equipment, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

A network expends numerous resources when collecting data to improve network quality. A minimization of drive tests (MDT) function may be specified to offload a portion of the data collection (e.g., radio measurement collections) to a user equipment (UE). A network may configure an MDT session and propagate the MDT session configuration via a control plane, such as radio resource control (RRC) messaging. For example, a base station may transmit an MDT logging message including a logging measurement configuration to a UE. In this example, the UE may initiate an MDT session in response to receiving the MDT logging message.

The logging measurement configuration includes one or more information elements. During the MDT session, the UE generates an MDT log based on measurements obtained for the configured information elements. The measurements may be collected at each logging instance of a number of logging instances until completion of the MDT session. After completing the MDT session, the UE may transmit a report to the base station indicating successful collection of the MDT logs. The UE may then transmit the collected MDT logs, in response to receiving a request from the base station. The MDT session and the reporting of the MDT logs may be separately configured by the base station. Network coverage optimization may be improved based on measurements provided in the MDT logs reported by the UE.

As network technologies advance, a size of the MDT logs may increase. Still, an amount of data allocated for MDT log transmission may be limited. Therefore, MDT logs may be segmented and transmitted via multiple uplink messages. It may be desirable to reduce a number of messages transmitted from a transmitter, such as a UE, to a receiver, such as a base station. Aspects of the present disclosure are directed to removing redundant information and/or redundant messages to reduce network overhead. In one configuration, redundant information is removed to reduce a size of the MDT logs, thereby reducing MDT log segmentation and reducing network overhead. Aspects of the present disclosure are not limited to removing redundant information from the MDT logs to reduce a size of the MDT logs. The present disclosure contemplates the removal of other types of redundant information and/or messages. For example, aspects of the present disclosure may remove redundant over the air (OTA) signaling messages.

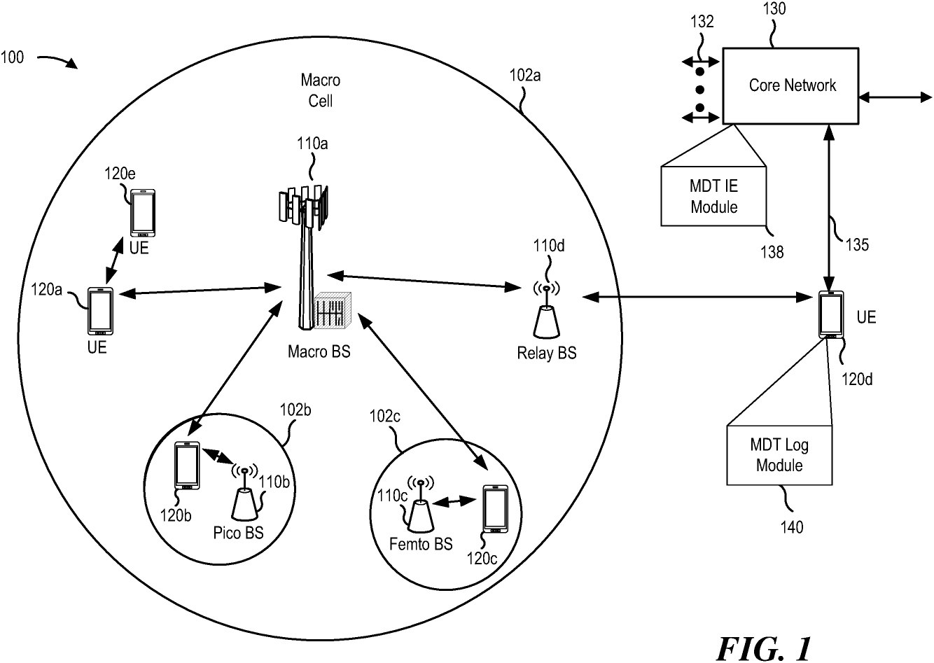

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B (NB), an access point, a transmit and receive point (TRP), and/or the like. Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB,” “base station,” “NR BS,” “gNB,” “TRP,” “AP,” “node B,” “5G NB,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types, e.g., macro BSs, pico BSs, femto BSs, relay BSs, and/or the like. These different types of BSs may have different transmit power levels, different coverage areas, and different impact on interference in the wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

As an example, the BSs 110 (shown as BS 110a, BS 110b, BS 110c, and BS 110d) and the core network 130 may exchange communications via backhaul links 132 (e.g., S1, etc.). Base stations 110 may communicate with one another over other backhaul links (e.g., X2, etc.) either directly or indirectly (e.g., through core network 130). The UEs 120 (e.g., 120a, 120b, 120c) may communicate with the core network 130 through a communications link 135.

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator’s IP services. The operator’s IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (e.g., S1, S2, etc.) and may perform radio configuration and scheduling for communications with the UEs 120. In some configurations, various functions of each access network entity or base station 110 may be distributed across various network devices (e.g., radio heads and access network controllers) or consolidated into a single network device (e.g., a base station 110).

UEs 120 (e.g., 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

The UEs 120 may include a log module 140. For brevity, only one UE 120d is shown as including the log module 140. The log module 140 may be configured to generate a number of measurement logs based on measurements performed by the UE, each measurement log generated at a different measurement instance. The log module 140 may also be configured to remove, for each measurement instance, a measurement from a measurement log of a current measurement instance when the measurement matches a prior measurement collected at a prior measurement instance. The log module 140 may further be configured to transmit, to the base station, a message comprising the measurement logs. The message may be a radio resource control (RRC) message, over the air (OTA) signaling message, or another type of message. In one configuration, the measurement logs are MDT logs.

The core network 130 or the base stations 110 may include an MDT information element (IE) module 138 configured to receive MDT logs from a UE 120. The MDT IE module 138 may identify missing information elements from MDT logs. If an information element is missing, the MDT IE module 138 may use a measurement value for the information element received in a previous MDT log.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communications link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (e.g., a system information block (SIB).

As indicated above, FIG. 1 is provided merely as an example. Other examples may differ from what is described with regard to FIG. 1.

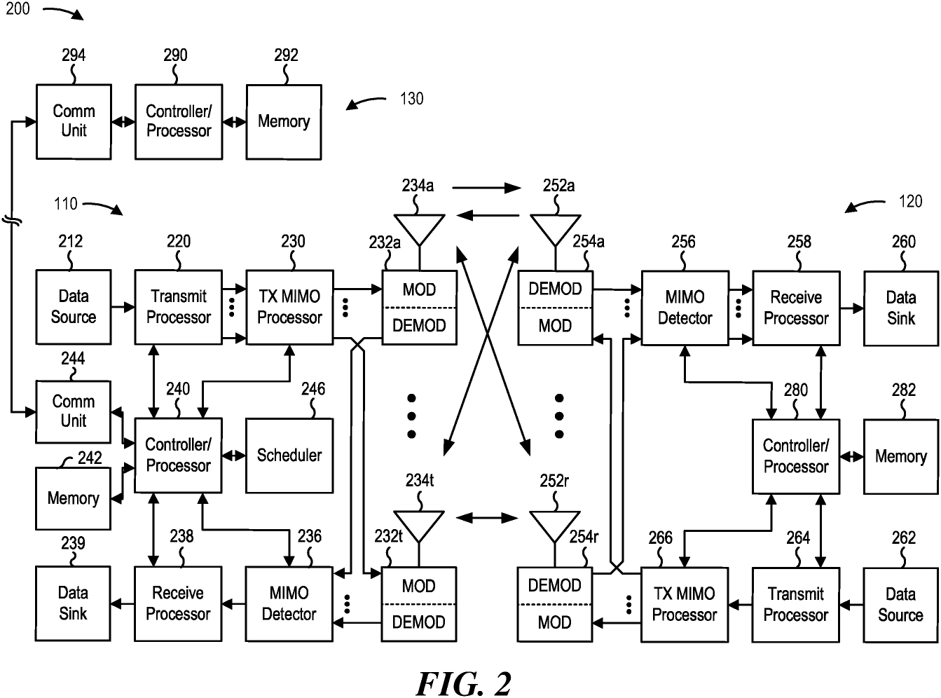

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T ≥ 1 and R ≥ 1.

At the base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Decreasing the MCS lowers throughput but increases reliability of the transmission. The transmit processor 220 may also process system information (e.g., for semi-static resource partitioning information (SRPI) and/or the like) and control information (e.g., CQI requests, grants, upper layer signaling, and/or the like) and provide overhead symbols and control symbols. The transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (e.g., for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (e.g., for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

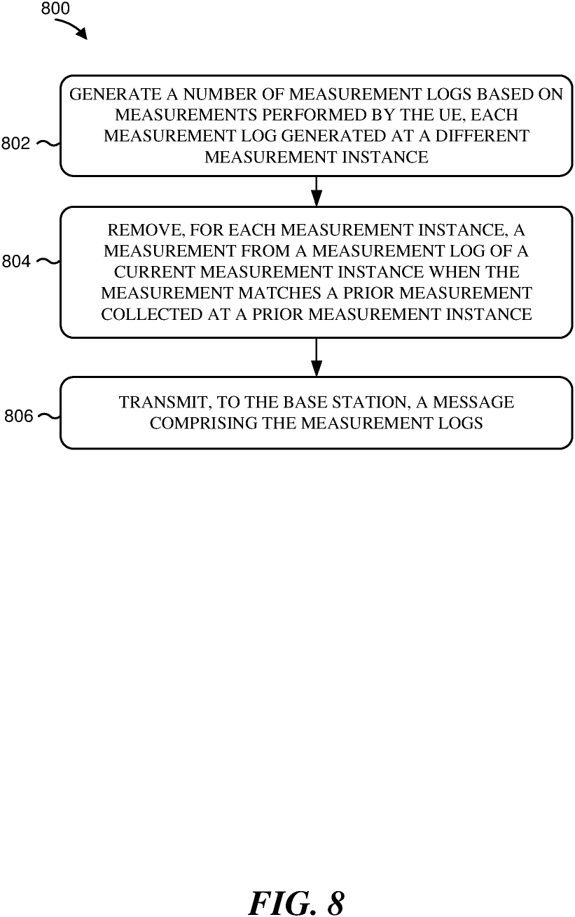

The controller/processor 240 of the base station 110, the controller/processor 280 of the UE 120, and/or any other component(s) of FIG. 2 may perform one or more techniques associated with removing redundant information and/or redundant messages described in more detail elsewhere. For example, the controller/processor 240 of the base station 110, the controller/processor 280 of the UE 120, and/or any other component(s) of FIG. 2 may perform or direct operations of, for example, the process of FIG. 8 and/or other processes as described. Memories 242 and 282 may store data and program codes for the base station 110 and UE 120, respectively. A scheduler 246 may schedule UEs for data transmission on the downlink and/or uplink.

In some aspects, the UE 120 may include means for generating a number of measurement logs based on measurements performed by the UE, each measurement log generated at a different measurement instance; means for removing, for each measurement instance, a measurement from a measurement log of a current measurement instance when the measurement matches a prior measurement collected at a prior measurement instance; and means for transmitting, to the base station, a message comprising the measurement logs.

Such means may include one or more components of the UE 120 or base station 110 or any other component described in connection with FIG. 2.

As indicated above, FIG. 2 is provided merely as an example. Other examples may differ from what is described with regard to FIG. 2.

As described above, a network expends numerous resources, such as capital resources and operating resources, to collect data for network improvement. A minimization of drive tests (MDT) function may be specified to offload a portion of the data collection (e.g., radio measurement collections) to a user equipment (UE). A network may configure an MDT session and propagate the MDT session configuration via a control plane, such as radio resource control (RRC) messaging. For example, a base station may transmit an MDT logging message including a logging measurement configuration to a UE. In response to receiving the MDT logging message, the UE may initiate an MDT session.

During the MDT session, the UE may generate an MDT log including measurements based on information elements configured in the logging measurement configuration. The measurements may be collected at each logging instance of a number of logging instances until completion of the MDT session. After completing the MDT session, the UE may transmit a report to the base station indicating successful collection of the MDT logs. The UE may then transmit the collected MDT logs, in response to receiving a request from the base station. The MDT session and the reporting of the MDT logs may be separately configured by the base station. Network coverage optimization may be improved based on measurements provided in the MDT logs reported by the UE.

As network technologies advance, a size (e.g., memory footprint) of the MDT logs may increase due to an increase in an amount of measured data. Still, an amount of data allocated for MDT log transmission may be limited. Therefore, MDT logs may be segmented and each MDT log segment may be transmitted via one of multiple uplink messages. Aspects of the present disclosure are directed to removing redundant information and/or redundant messages to reduce network overhead. In one configuration, redundant information is removed to reduce a size of the MDT logs, thereby reducing MDT log segmentation and reducing network overhead.

Aspects of the present disclosure are not limited to removing redundant information from the MDT logs to reduce a size of the MDT logs. The present disclosure contemplates the removal of other types of redundant information and/or messages. For example, aspects of the present disclosure may remove redundant over the air (OTA) signaling messages and/or redundant information from OTA signaling messages. In some examples, OTA signaling messages may include one or more measurements performed by a UE, or a base station, such as signal power, interference, antenna characteristics, signal dominance, and/or other types of measurements.

For ease of explanation, aspects of the present disclosure are described with reference to removal of redundant information from the MDT logs. As described, a UE may be configured to perform measurements at each logging instance (e.g., point of time) of multiple logging instances during an MDT session. The measurements may be performed while the UE is in an idle state. Additionally, the measurements at each logging instance may be collected, and information elements for the measurements may be stored in a measurement log for reporting to the base station. For ease of explanation, the measurement log is referred to as an MDT log. The MDT log may also be referred to as a measurement report. The measurements may also be referred to as MDT measurements. The MDT log may include one or more information elements for the MDT measurements.

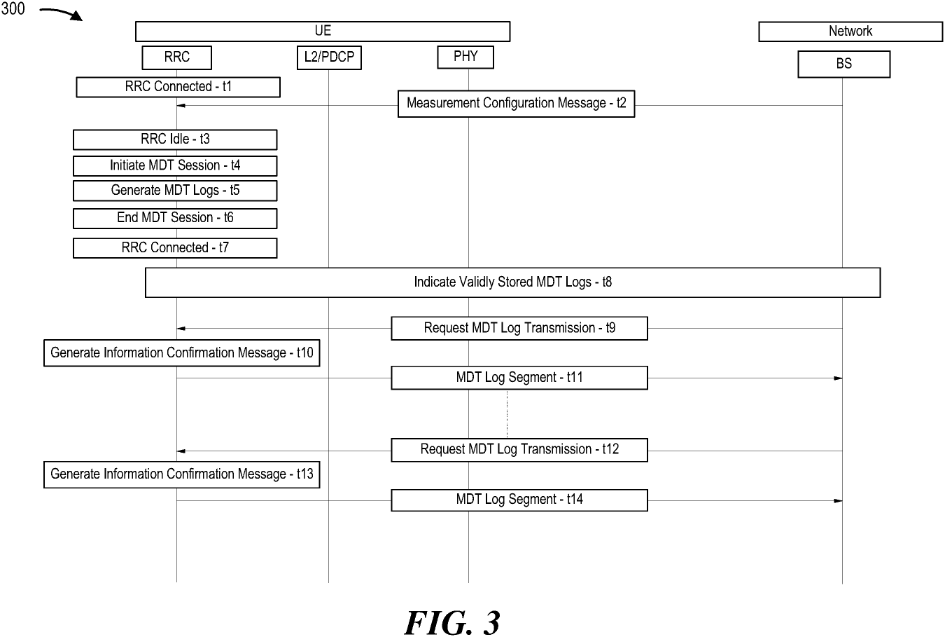

FIG. 3 is a timing diagram 300 illustrating an example of a minimization of drive tests (MDT) process. As shown in FIG. 3, at time t1, a UE is in a radio resource control (RRC) connected mode. The UE may establish a user plane (UP) and control plane connection with the network when in the RRC connected mode. For ease of explanation, the network will be referred to as a base station (shown as BS in FIG. 3). The UE may be a UE 120 as described with reference to FIG. 1, and the base station may be a base station 110 as described with reference to FIG. 1.

In some cases, a base station may obtain the UE capability information, including logged MDT support capability information, provided in an initial context setup request message transmitted by the mobility management entity (MME) (not shown in FIG. 3) during the initial context setup procedure. At time t2, the base station transmits a measurement configuration message including a logging measurement configuration. The measurement configuration received at time t2 may be a LoggedMeasurementConfiguration information element. Additionally, the measurement configuration may configure the UE to perform measurements for a number of measurement types included in the measurement configuration.

At time t3, the UE enters an RRC idle state. Based on the measurement configuration received at time t2, the UE initiates an MDT session at time t4. That is, the UE initiates the MDT session after entering the RRC idle state. At time t5, the UE generates an MDT log at each logging instance for the duration of the MDT session based on the MDT measurements collected at the logging instance. That is, at time t5, the UE performs MDT measurements for one or more information elements configured by the measurement configuration received at time t2. The MDT logs may be generated at an RRC level of the UE. The logging instance and a duration of the MDT session may be configured by the base station.

As shown in FIG. 3, at time t6, the MDT session is complete. The UE stores the MDT logs after completion of the MDT session. The MDT logs may be stored for a time period, such as, for example, forty-eight hours. A size of each MDT log may vary. For example, in conventional systems, the size of an MDT log may be 64 KB or 3 MB.

At time t7, the UE enters the RRC connected mode. After entering the RRC connected mode, the UE transmits a message to the base station indicating that it has validly stored the MDT logs (time t8). The indication may be provided via a log measurement available information element, such as logMeasAvailable. The information element may be provided in an RRC connection completion message, such as an RRCConnectionSetupComplete message transmitted during connection establishment, an RRCConnectionReconfigurationComplete message transmitted during a handover, or an RRCConnectionReestablishmentComplete message transmitted during a connection re-establishment process.

In response to receiving the indication of validly stored MDT logs, the base station transmits a request message requesting the MDT logs (time t9). At time t10, in response to receiving the request message, the UE generates a UE information confirmation message including the collected MDT logs. The UE information confirmation message may be a type of RRC message.

The information confirmation message generated at time t10 may not include all of the collected MDT logs because lower layers of a network connection restrict a size of an RRC message. In some cases, the size is restricted to 8188 bytes. Based on the size restriction, the UE may segment the MDT logs (not shown in FIG. 3). For example, if an MDT log is 64 KB, the UE may segment the MDT log into eight segments, where each segment is 8 KB. As described, MDT logs may vary in size. Therefore, the segments may be greater than or less than eight. In the current example, at time t11, the UE transmits one segment of one of the collected MDT logs. In response to receiving one segment of one of the collected MDT logs, at time 112, the base station transmits a request message requesting the MDT logs. At time t13, the UE generates a second UE information confirmation message including a segment of one of the collected MDT logs. The MDT log segment is transmitted in the second UE information message at time t14. The process described for times t10-t14 may repeat until each segment of the MDT logs is transmitted to the base station.

In advanced LTE releases (such as Release 13 and beyond), the measurement configuration, such as the LoggedMeasurementConfiguration information element, may configure the UE to include wireless local area network (WLAN) measurements and/or Bluetooth™ (BT) information elements in the MDT logs. For example, the LoggedMeasurementConfiguration message may include a UE-BasedNetwPerfMeasParameters-v1530 information element defining new optional measurement parameters for wireless local area networks and Bluetooth, such as loggedMeasBT-r15, loggedMeasWLAN-r15, immMeasBT-r15, and immMeasWLAN-r15. As a result of the new measurement parameters, a size of the MDT logs has increased, thereby increasing a number of RRC message segments for each MDT log collected by the UE.

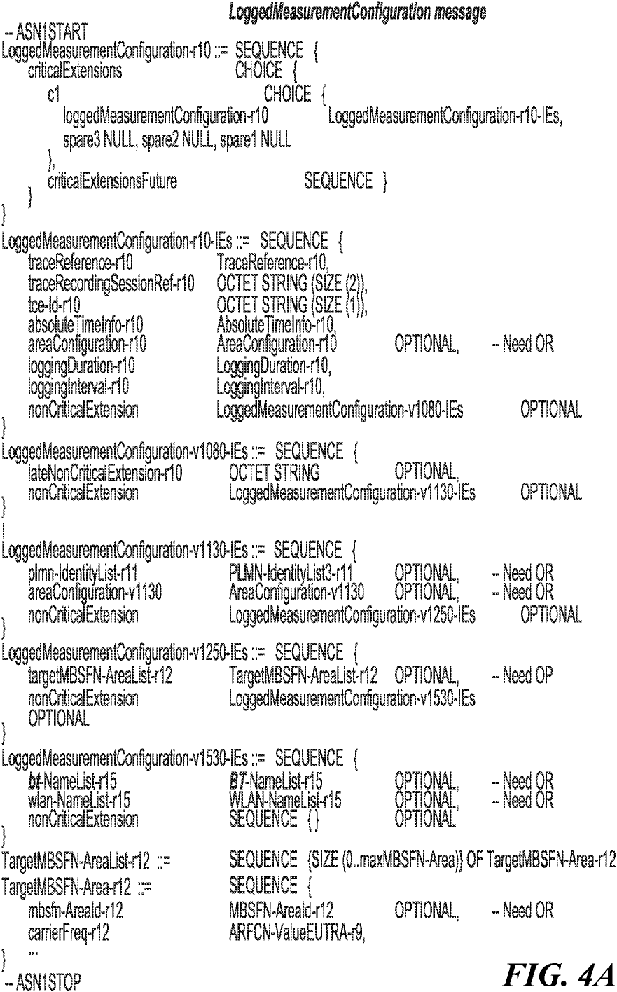

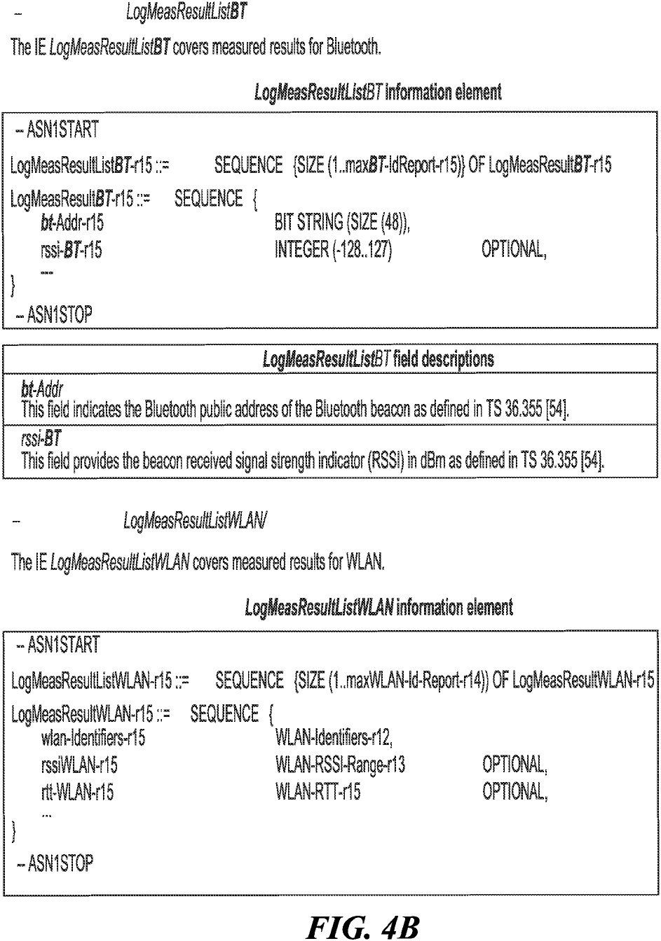

FIG. 4A illustrates an example of a LoggedMeasurementConfiguration message. As shown in FIG. 4A, the LoggedMeasurementConfiguration message may also include new information elements (IEs) for wireless local area networks and Bluetooth, such as bt-NameList-r15 and wlan-NameList-r16. As shown in FIG. 4A, the bt-NameList-r15 and wlan-NameList-r16 are optional.

As described, the UE may obtain MDT measurements for information elements configured in the measurement configuration. FIG. 4B illustrates an example of a Bluetooth information element. As shown in FIG. 4B, the Bluetooth information element (shown as LogMeasResultListBT) provides Bluetooth measurements. The Bluetooth information element may provide a Bluetooth public address of a Bluetooth beacon (shown as bt-Addr-r15), and may optionally provide a received signal strength indicator (RSSI) (shown as rssi-BT-r15).

FIG. 4B also illustrates an example of a WLAN information element. As shown in FIG. 4B, the WLAN information element (shown as LogMeasResultListWLAN) provides WLAN measurements. The WLAN information element may provide WLAN identifiers (shown as wlan-Identifiers-r-15), a received signal strength indicator (RSSI) (shown as rssiWLAN-r15), and a round trip time (RTT) (shown as rtt-WLAN-r15). The received signal strength indicator and round trip time may be optional

Network bandwidth and network device resources may increase as a number of communicated messages increase. These messages may include, for example, RRC messages and OTA signaling message. To decrease network bandwidth and reduce a number of resources (e.g., processing power, transmission resources, memory, etc.) used by a network device, such as a UE, it is desirable to reduce redundant information and/or redundant messages. In one configuration, redundant information elements are removed to reduce a number of MDT log segments. Each segment may be generated by segmenting RRC messages including MDT logs. In some implementations, the MDT logs include one or more information elements for MDT measurements, such as NR information elements, WLAN information elements, and/or Bluetooth information elements. Aspects of the present disclosure are not limited to MDT logs with NR information elements, WLAN information elements, and/or Bluetooth information elements; other information elements may be included as an addition, or an alternate, to the NR information elements, WLAN information elements, and/or Bluetooth information elements. The information elements for the MDT measurements may be requested by a manufacturer (e.g., original equipment manufacturer (OEM)) and/or a network operator.

As described, current 3GPP Standards Releases, such as Release 15, do not specify techniques for reducing the number of MDT log segments. In one configuration, segmentation is reduced by filtering (e.g., removing) redundant information elements from one or more MDT logs. In some examples, the redundant information elements may include, for example, a serving cell identifier (ID) (e.g., identity), a neighbor cell ID, a carrier frequency, an inter-radio access technology (IRAT) ID, a WLAN ID, and/or a Bluetooth ID.

For example, in conventional systems, the measurement configuration designates the serving cell ID (servCellIdentity-r10) as a mandatory information element. Each MDT log may designate forty bits for reporting the serving cell ID. Still, if the UE has remained on a same serving cell between two or more consecutive timing intervals, the serving cell ID may be redundant. Therefore, after including the serving cell ID information element in an initial MDT log, the serving cell ID information element may be excluded from a current MDT log (N) if the current serving cell ID is a same serving cell ID collected for a previous MDT log (N-1).

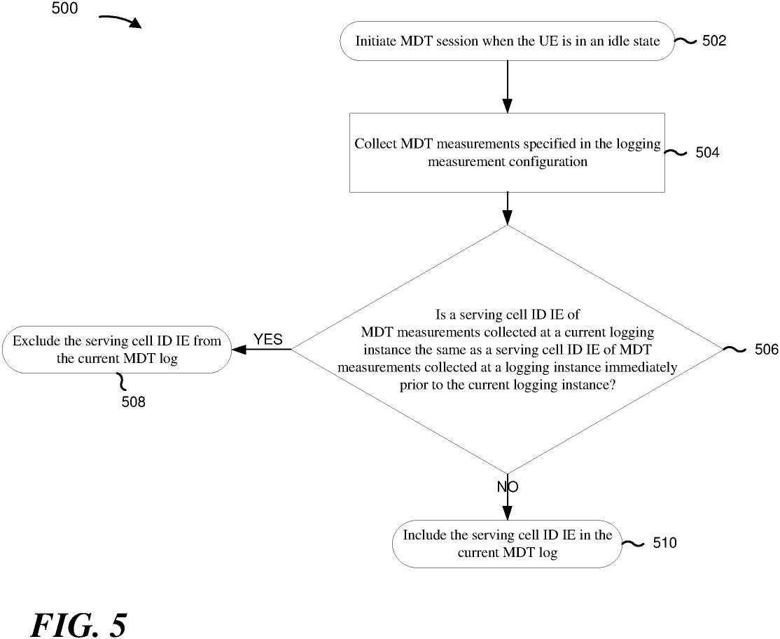

FIG. 5 is a flow diagram 500 illustrating an example process for removing a redundant information element, in accordance with aspects of the present disclosure. For ease of explanation, the flow diagram 500 is described for the MDT measurement specified for the serving cell ID information element (e.g., servCellIdentity-r10). Still, the flow diagram 500 may be applicable to other information elements, such as, a neighbor cell ID, a carrier frequency, an IRAT ID, a WLAN ID, and a Bluetooth ID.

As shown in FIG. 5, at block 502, the UE initiates an MDT session when the UE is in an idle state. At block 504, at a current logging instance, the UE collects MDT measurements specified in the logging measurement configuration. The MDT measurements collected at the current logging instance may be for information elements (IEs) provided in an MDT log for the current logging instance. The MDT measurements may be collected at an RRC layer of the UE.

As shown in FIG. 5, to reduce redundant MDT measurements in the MDT logs, at block 506, the UE determines if a serving cell ID information element (IE) of MDT measurements collected at a current logging instance (N) is the same as a serving cell ID information element of MDT measurements collected at a logging instance immediately prior to the current logging instance (e.g., a previous logging instance (N-1)). If the serving cell IDs are the same, the UE does not include the serving cell ID information element in the MDT log for the current logging instance (block 508). For example, when a UE is indoors or stationary, the serving cell ID, neighbor cell ID, and/or other information elements may not change across a number of logging instances.

If the serving cell IDs information elements are different, the UE includes the serving cell ID information element in the MDT log for the current logging instance (block 510). The serving cell IDs may be different if the UE switches to a new serving cell between consecutive logging instances. The process of blocks 504-510 may repeat for each logging instance until the MDT session is complete.

In one configuration, when an MDT log does not include an information element, the base station associates the information element to an information element included in a previous MDT log. For example, if the serving cell ID did not change after collecting MDT measurements for an initial MDT log, the MDT logs subsequent to the initial MDT log may not include the serving cell ID information element. In this example, the base station associates the serving cell ID information element to the serving cell ID information element included in the initial MDT log.

Additionally, in the current example, if an MDT log for a logging instance after an initial logging instance of the initial MDT log includes a new serving cell ID information element, the network may detect a change of cell ID. The serving cell ID information element for subsequent MDT logs may be associated with the new serving cell ID information element.

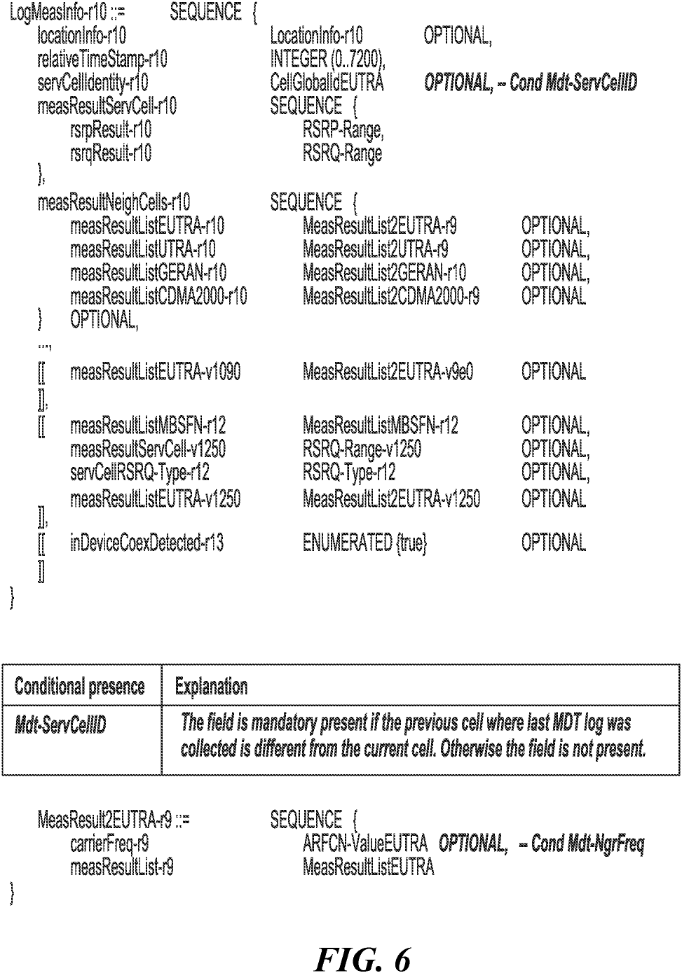

According to aspects of the present disclosure, a log measurement information element is updated to reduce redundant MDT measurements. FIG. 6 illustrates an example of a serving cell information element for serving cell measurements (shown as servCellIdentity-r10) and a carrier frequency information element (shown as carrierFreq-r9) for carrier frequency measurements, in accordance with aspects of the present disclosure. In the example of FIG. 6, the serving cell ID MDT information element (shown as servCellIdentity-r10) is updated to conditional optional (shown as OPTIONAL, -- Cond Mdt-ServCellID), where the serving cell ID MDT information element is mandatory if the previous cell for the last MDT log is different from the current cell. If the previous cell is the same as the current cell, the serving cell ID MDT information element is not included in the current MDT log.

Additionally, or alternatively, a neighbor carrier frequency MDT information element (shown as MeasResultList2EUTRA) may be updated to conditional optional. The neighbor carrier frequency may be an LTE neighbor. As shown in FIG. 6, the carrier frequency MDT information element is set to conditional optional (shown as OPTIONAL, -- Cond Mdt-NgrFreq), where the carrier frequency MDT information element is mandatory if the neighbor cell in a last MDT log is different from a current neighbor of a same serving cell. If the neighbor cells are the same, the carrier frequency MDT information element is not included in the current MDT log.

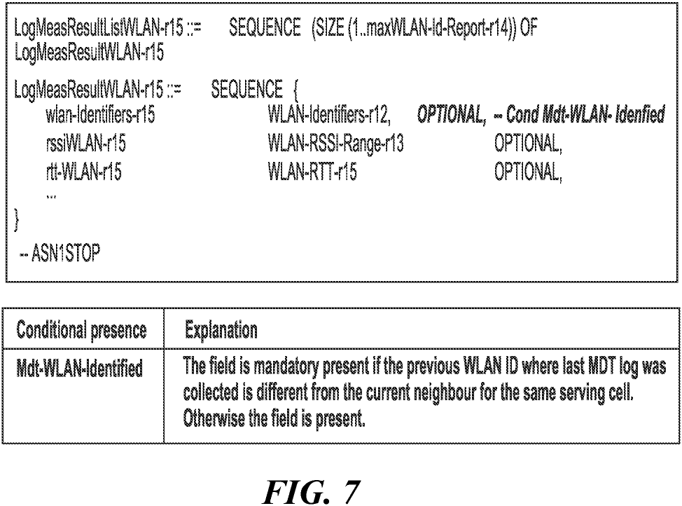

Additionally, or alternatively, the WLAN ID information element may be updated to conditional optional. FIG. 7 illustrates an example of an updated WLAN information element (shown as LogMeasResultListWLAN-r15) for WLAN measurements, in accordance with aspects of the present disclosure. As shown in FIG. 7, the WLAN ID information element is set to conditional optional (shown as OPTIONAL, -- Cond Mdt-WLAN- Identified), where the WLAN ID information element is mandatory if the WLAN ID in a last MDT log is different from a current WLAN ID for a same serving cell. If the WLAN IDs are the same, the WLAN ID information element is not included in the current MDT log.

Additionally, or alternatively, the Bluetooth ID information element may be updated to conditional optional. For example, a Bluetooth ID information element, such as bt-Addr-r15, of a Bluetooth measurement, such as LogMeasResultBTList-r15, may be conditional optional.

A neighbor cell ID information element, such as the cgi-Info information element specified in the log measurement information element may also be conditional optional based on a change of neighbor cell IDs.

As described, according to an aspect of the present disclosure, if the serving cell is the same in M consecutive logging instances, the UE includes the serving cell ID information element (servCellldentity-r10) only in an initial MDT log of the M consecutive logging instances. The serving cell ID information element may be excluded from subsequent MDT logs of the M consecutive logging instances.

Additionally, or alternatively, if all neighbor cells are the same for P consecutive log instances, the UE includes the neighbor cell ID information element (cgi-Info) only in an initial MDT log of the P consecutive logging instances. The neighbor cell ID information element may be excluded from subsequent MDT logs of the P consecutive logging instances.

Additionally, or alternatively, according to another aspect of the present disclosure, the UE includes the WLAN ID information element and/or Bluetooth ID information element only in an initial MDT log of the X consecutive logging instances. The WLAN ID information element and/or Bluetooth ID information element may be excluded from subsequent MDT logs of the X consecutive logging instances.

As indicated above, FIGS. 3-7 are provided as examples. Other examples may differ from what is described with respect to FIGS. 3-7.

FIG. 8 is a diagram illustrating an example process 800 performed, for example, by a UE, in accordance with various aspects of the present disclosure. The example process 800 is an example of redundant information and/or redundant message removal to reduce radio resource control (RRC) message segmentation. As shown in FIG. 8, in some aspects, the process 800 may include generating a number of measurement logs based on measurements performed by the UE, each measurement log generated at a different measurement instance (block 802). For example, the user equipment (UE) (for example, using the antenna 252a, DEMOD/MOD 254a, MIMO detector 256, receive processor 258, controller processor 280, and/or memory 282) may generating a number of measurement logs based on measurements performed by the UE.

As shown in FIG. 8, in some aspects, the process 800 may include removing, for each measurement instance, a measurement from a measurement log of a current measurement instance when the measurement matches a prior measurement collected at a prior measurement instance (block 802). For example, the user equipment (UE) (for example, controller processor 280, and/or memory 282) may remove the measurement.

As shown in FIG. 8, in some aspects, the process 800 may include transmitting, to the base station message comprising the plurality measurement logs (block 804). For example, the user equipment (UE) (for example, using the antenna 252r, DEMOD/MOD 254r, TX MIMO processor 266, transmit processor 264, controller processor 280, and/or memory 282) may transmit, to the base station.

Implementation examples are described in the following numbered clauses:
1. A method performed by a user equipment (UE), comprising: generating a plurality of measurement logs based on measurements performed by the UE, each measurement log generated at a different measurement instance; removing, for each measurement instance, a measurement from a measurement log of a current measurement instance when the measurement matches a prior measurement collected at a prior measurement instance; and transmitting, to a base station, a message comprising the plurality measurement logs.
2. The method of clause 1, in which the message comprises a radio resource control (RRC) message or an over the air (OTA) signaling message.
3. The method of any of clauses 1-2, in which the measurement session comprises a minimization of drive tests (MDT) session, and the measurement log comprises an MDT log.
4. The method of clause 3, in which the MDT log comprises an information element comprising information obtained based on measurements performed at a measurement instance, and the information element comprises a serving cell identifier, a neighbor cell identifier, a neighbor cell frequency, a wireless local area network (WLAN) identifier, or a Bluetooth address.
5. The method of clause 3, further comprising receiving a measurement configuration message comprising a logging measurement configuration during a radio resource control (RRC) connected mode.
6. The method of clause 5, further comprising initiating the MDT session during a radio resource control (RRC) idle mode.
7. The method of any of clauses 1-16, further comprising generating the plurality of measurement logs during a UE-specific measurement session or location-specific measurement session.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method performed by a user equipment (UE), comprising:
generating a plurality of measurement logs based on measurements performed by the UE, each measurement log generated at a different measurement instance;
removing, for each measurement instance, a measurement from a measurement log of a current measurement instance when the measurement matches a prior measurement collected at a prior measurement instance; and
transmitting, to a base station, a message comprising the plurality measurement logs.

2. The method of claim 1, in which the message comprises a radio resource control (RRC) message or an over the air (OTA) signaling message.

3. The method of claim 1, in which the measurement session comprises a minimization of drive tests (MDT) session, and the measurement log comprises an MDT log.

4. The method of claim 3, in which the MDT log comprises an information element comprising information obtained based on measurements performed at a measurement instance, and the information element comprises a serving cell identifier, a neighbor cell identifier, a neighbor cell frequency, a wireless local area network (WLAN) identifier, or a Bluetooth address.

5. The method of claim 3, further comprising receiving a measurement configuration message comprising a logging measurement configuration during a radio resource control (RRC) connected mode.

6. The method of claim 5, further comprising initiating the MDT session during a radio resource control (RRC) idle mode.

7. The method of claim 1, further comprising generating the plurality of measurement logs during a UE-specific measurement session or location-specific measurement session.

8. A apparatus for wireless communication at a user equipment (UE), comprising:
means for generating a plurality of measurement logs based on measurements performed by the UE, each measurement log generated at a different measurement instance;
means for removing, for each measurement instance, a measurement from a measurement log of a current measurement instance when the measurement matches a prior measurement collected at a prior measurement instance; and
means for transmitting, to a base station, a message comprising the plurality measurement logs.

9. The apparatus of claim 8, in which the message comprises a radio resource control (RRC) message or an over the air (OTA) signaling message.

10. The apparatus of claim 8, in which the measurement session comprises a minimization of drive tests (MDT) session, and the measurement log comprises an MDT log.

11. The apparatus of claim 10, in which the MDT log comprises an information element comprising information obtained based on measurements performed at a measurement instance, and the information element comprises a serving cell identifier, a neighbor cell identifier, a neighbor cell frequency, a wireless local area network (WLAN) identifier, or a Bluetooth address.

12. The apparatus of claim 10, further comprising means for receiving a measurement configuration message comprising a logging measurement configuration during a radio resource control (RRC) connected mode.

13. The apparatus of claim 12, further comprising means for initiating the MDT session during a radio resource control (RRC) idle mode.

14. The apparatus of claim 8, further comprising means for generating the plurality of measurement logs during a UE-specific measurement session or location-specific measurement session.

15. A apparatus for wireless communication at a user equipment (UE), comprising:
a processor;
a memory coupled with the processor; and
instructions stored in the memory and operable, when executed by the processor, to cause the apparatus:
to generate a plurality of measurement logs based on measurements performed by the UE, each measurement log generated at a different measurement instance;
to remove, for each measurement instance, a measurement from a measurement log of a current measurement instance when the measurement matches a prior measurement collected at a prior measurement instance; and
to transmit, to a base station, a message comprising the plurality measurement logs.

16. The apparatus of claim 15, in which the message comprises a radio resource control (RRC) message or an over the air (OTA) signaling message.

17. The apparatus of claim 15, in which the measurement session comprises a minimization of drive tests (MDT) session, and the measurement log comprises an MDT log.

18. The apparatus of claim 17, in which the MDT log comprises an information element comprising information obtained based on measurements performed at a measurement instance, and the information element comprises a serving cell identifier, a neighbor cell identifier, a neighbor cell frequency, a wireless local area network (WLAN) identifier, or a Bluetooth address.

19. The apparatus of claim 17, in which the instructions further cause the apparatus to receive a measurement configuration message comprising a logging measurement configuration during a radio resource control (RRC) connected mode.

20. The apparatus of claim 19, in which the instructions further cause the apparatus to initiate the MDT session during a radio resource control (RRC) idle mode.

21. The apparatus of claim 15, in which the instructions further cause the apparatus to generate the plurality of measurement logs during a UE-specific measurement session or location-specific measurement session.

22. A non-transitory computer-readable medium having program code recorded thereon for wireless communication by a user equipment (UE), the program code executed by a processor and comprising:
program code to generate a plurality of measurement logs based on measurements performed by the UE, each measurement log generated at a different measurement instance; program code to remove, for each measurement instance, a measurement from a measurement log of a current measurement instance when the measurement matches a prior measurement collected at a prior measurement instance; and
program code to transmit, to a base station, a message comprising the plurality measurement logs.

23. The non-transitory computer-readable medium of claim 22, in which the message comprises a radio resource control (RRC) message or an over the air (OTA) signaling message.

24. The non-transitory computer-readable medium of claim 22, in which the measurement session comprises a minimization of drive tests (MDT) session, and the measurement log comprises an MDT log.

25. The non-transitory computer-readable medium of claim 24, in which the MDT log comprises an information element comprising information obtained based on measurements performed at a measurement instance, and the information element comprises a serving cell identifier, a neighbor cell identifier, a neighbor cell frequency, a wireless local area network (WLAN) identifier, or a Bluetooth address.

26. The non-transitory computer-readable medium of claim 24, in which the program code further comprises program code to receive a measurement configuration message comprising a logging measurement configuration during a radio resource control (RRC) connected mode.

27. The non-transitory computer-readable medium of claim 26, in which the program code further comprises program code to initiate the MDT session during a radio resource control (RRC) idle mode.

28. The apparatus of claim 22, in which the program code further comprises program code to generate the plurality of measurement logs during a UE-specific measurement session or location-specific measurement session.
